(19) United States
(12) Patent Application Publication
(10) Pub. No.: US 2011/0090145 A1
(43) Pub. Date: Apr. 21, 2011

(54) METHOD AND ELECTRONIC SYSTEM FOR MULTI-DIRECTIONAL INPUT

(75) Inventor: LEE-YU LU, TAIPEI COUNTY (TW)

(73) Assignee: ACER INCORPORATED, TAIPEI COUNTY (TW)

(21) Appl. No.: 12/697,301

(22) Filed: Feb. 1, 2010

(30) Foreign Application Priority Data
Oct. 15, 2009 (TW) 098135000

(51) Int. Cl. G09G 5/00; G06F 21/00

(52) U.S. Cl. 345/156; 713/182

(57) ABSTRACT

A multi-directional input method is applicable to an authentication process of electronic software run on an electronic system. According to the method, when the authentication process is initialized, an authentication module having a multi-directional input object and entry fields is loaded. The multi-directional input object has multiple input sides, which together constitute a polyhedron and each have multiple input units. The input units each corresponds to at least one input options can be selected via an input device of the electronic system to constitute a required authentication data for inputting to the entry field. The authentication module verifies the validity of the input authentication data, and a next function of the electronic system is provided for use when the input authentication data is verified as valid. The multi-directional input method prevents authentication data from being illegally recorded to thereby provide enhanced security protection.

### FIELD OF THE INVENTION

The present invention relates to an input method and an electronic system, and more particularly to a multi-directional input method and an electronic system.

### BACKGROUND OF THE INVENTION

Generally, when a user wants to use the operating system run on a computer, such as the Microsoft Windows operating system, the Linux operating system, or the UNIX operating system, the operating system run on a mobile phone, such as the Microsoft Windows Mobile operating system or the Android operating system, or a variety of application programs run on other electronic devices, such as MSN, database software, digital surveillance software, electronic game software. The user of the operating system has to follow an authentication process to validate the user's login identity and password before the user can start using the operating system or application programs of the electronic device.

For example, when the Microsoft Windows operating system is initialized and in the event it is necessary to input an authentication data, the operating system will load an authentication process and provide an authentication window, on which an identification field and a password field are displayed. The user can operate an input device, such as a physical keyboard, a virtual keyboard, a touch screen or the like, to input ASCII characters one by one, such as A, C, 6, or 2, in the identification field and the password field, so as to constitute the authentication data for verifying the user's identification number and password. When the input authentication data is verified as correct data, the operating system will then execute an internal program or other interfaces, and the user is allowed to start using the operating system and the application programs thereof.

When the user inputs the identification number and the password using the conventional input devices, the input authentication data, such as the identification number and the password, are subject to the risk of being stolen in the event the operating system has already been invaded by a hacker program capable of decoding the input identification number and password. Currently, there are mainly two kinds of stealing the authentication data:

(A) When the user is inputting the password, an illegal keylogger may be loaded in the operating system to record the inputted ASCII characters to thereby track and steal the ASCII characters corresponding to the password and the length thereof.

(B) After the user has inputted the password, illegal logging software may be loaded in the operating system to access the password entry field. The logging software is able to access the storage unit, storing data corresponding to the password entry field, of the operating system, and then steals and thereby obtains the ASCII characters of the password and the length thereof.

The users of the operating system are frequently unaware of the illegal keylogger and the illegal logging software loaded in the operating system when the user browses some web pages or uses some free download software or illegal copied software. Thus, every time a user using the operating system or the application programs, he is hard to perceive that the authentication data inputted via the conventional input device has already been stolen by the keylogger or the logging software.

Thus, many software manufacturers have designed various authentication data input methods against hacker programs. For example, Microsoft has developed the Windows Virtual Keyboard, on which characters are arranged corresponding to the physical keyboard. Alternatively, whenever the corresponding application program is initialized, the virtual keyboard is randomly shown at different positions in the window area on the screen, or different characters are shown beside an authentication field on a web page and corresponding to different figures to avoid the authentication data from being stolen.

Most of the currently available input methods provided against the illegal keylogger and the illegal logging software are designed based on the conventional input devices, such as the mouse and the physical keyboard. That is, the existing anti-recording and anti-logging input methods are restricted to the input behavior based on the conventional mouse or keyboard. There is lack of an input method that is designed based on a touch input device to prevent the authentication data from being stolen. Therefore, it is necessary to develop an input method available to both touch input devices and conventional input devices, so that authentication data input using such input method is protected from being stolen by the illegal keylogger or the illegal logging software.

### SUMMARY OF THE INVENTION

A primary object of the present invention is to provide a multi-directional input method and electronic system to solve the problem of the conventional input method that authentication data input is subject to being stolen by illegal recording or logging.

To achieve the above object, the multi-directional input method according to the present invention is applicable to an authentication process of electronic software run on an electronic system. According to the method, when the authentication process is initialized, an authentication module having a multi-directional input object and at least one entry field is loaded. The multi-directional input object has a plurality of input sides, which together constitute a polyhedron and each has a plurality of input units. Each of the input units corresponds to at least one input options and the input options may be selected via an input device of the electronic system to constitute a required authentication data and input to the entry field. The authentication module verifies the validity of the input authentication data, and the next function of the electronic software is available when the input authentication data is verified as valid.

According to the present invention, the input options can be characters, symbols, colors, or patterns. The characters, symbols, colors, or patterns corresponding to the input options are randomly arranged on different input units.

According to the present invention, the multi-directional input object and the input units can be independently turned, moved, resized, enlarged, or deformed.

To achieve the above object, the multi-directional input electronic system according to the present invention includes an authentication module, an input device, and a display unit. The authentication module includes a multi-directional input object and at least one entry field. The multi-directional input object has a plurality of input sides, which together constitute a virtual regular polyhedron, and each of the input sides has a plurality of input units. Each of the input units corresponds to at least one input options. The display device displays the multi-directional input object and the entry fields. The input device can be operated to select and input required authentication data to the entry fields. The authentication module verifies the validity of the input authentication data. When the input authentication data is verified by the authentication module as valid, the next function of the electronic system is available for use.

With the above arrangements, the multi-directional input method and electronic system of the present invention provide the following advantages:

(1) Each time the authentication data is put via the input device, the selected input options may be located at different positions on different input units of the multi-directional input object. Therefore, authentication data could not be easily decoded and stolen by hacker programs.

(2) Each time the authentication data is input via the input device, the selected input options can constitute the authentication data in a variety of combinations, so that the multi-directional input method provides enhanced security protection.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in a multi-directional input method according to the present invention;

FIG. 2 is a conceptual view of a multi-directional input object according to an embodiment of the present invention;

FIG. 3 is a flowchart showing the steps included in the multi-directional input method of the present invention for operating the multi-directional input object;

FIG. 4 is a conceptual view showing an embodiment of the present invention for operating the multi-directional input object;

FIG. 5 is a conceptual view showing an embodiment of the present invention for operating the multi-directional input object;

FIG. 6 is a flowchart showing the steps included in the multi-directional input method of the present invention for selecting one of many input options from one of many input units;

FIG. 7 is a conceptual view showing an embodiment of changing an outer appearance of the input units; and

FIG. 8 is a block diagram of a multi-directional input electronic system according to the present invention.

### DETAILED DESCRIPTION OF THE PREFERRED EMBODIMENTS

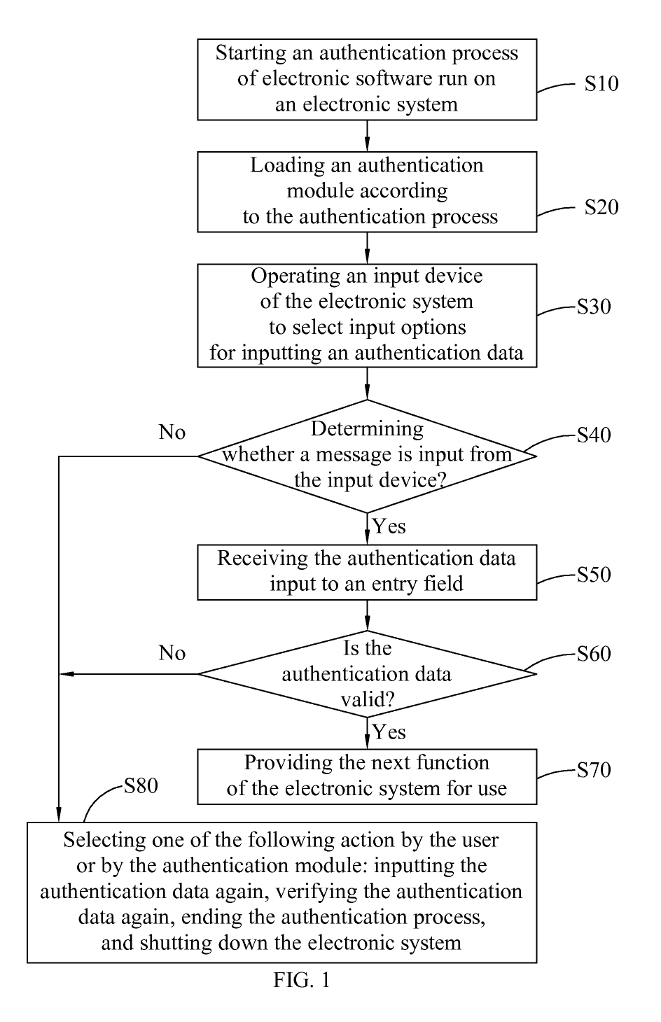

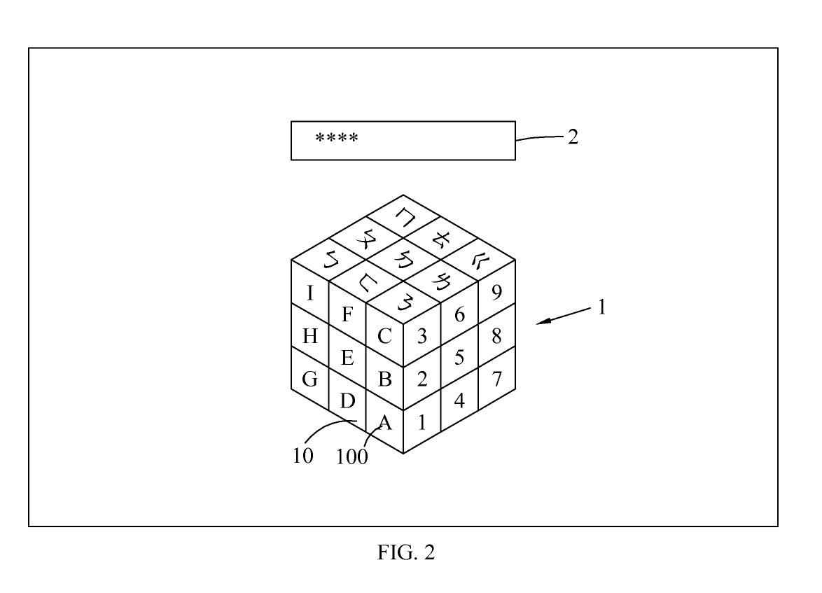

Please refer to FIG. 1 that is a flowchart showing the steps included in a multi-directional input method according to the present invention, and also refer to FIG. 2 that is a conceptual view of a multi-directional input object according to an embodiment of the present invention. The multi-directional input method is applicable to an authentication process of electronic software, such as an operating system or an application program, run on an electronic system, and includes the following steps:

In step S10, an authentication process of electronic software, such as an operating system or an application program, is started.

In step S20, an authentication module including a multi-directional input object 1 and at least one entry field 2 is loaded according to the authentication process. The multi-directional input object 1 has a plurality of input sides, which together constitute a regular polyhedron. On each of the input sides, there is a plurality of input units 10. Each of the input units 10 corresponds to at least one input option 100 for a user to select and input. Each of the input options 100 can be presented as, for example, a character, a symbol, a color or a pattern,

In step S30, an input device of the electronic system is used for performing selection and input of the input options to thereby operate the multi-directional input object 1, so that a plurality of the input units are sequentially selected, and input options 100 separately corresponding to the selected input units together constitute an authentication data, which is not displayed in the entry field 2 but replaced by asterisks. There may be two entry fields 2, including a password entry field and an identification data (ID) entry field. The password input to the password entry field and/or the ID data input to the ID entry field constitutes the authentication data.

In step S40, it is determined whether a message has been input from the input device. If yes, go to step S50; or if not, go to step S80.

In step S50, the authentication data in the entry field is received.

In step S60, whether the received authentication data is valid is verified by the authentication module. If yes, go the step S70; or if not, go to step S80.

In step S70, since the authentication data is verified as valid by the authentication module, the next function of the electronic system is provided for use.

In step S80, since the authentication data is verified as invalid by the authentication module, an authentication module may choose to go to the step S30 or the step S60, end the authentication process, or shut down the electronic device; alternatively, the user may determine to go to the step S30, go to the step S60, end the authentication process, or shut down the electronic device.

In brief, according to the present invention, an authentication data is constituted and input by selecting multiple input options 100 from different positions of the multi-directional input object 1. Thus, the multi-directional input method of the present invention provides higher security protection to prevent the authentication data from being stolen.

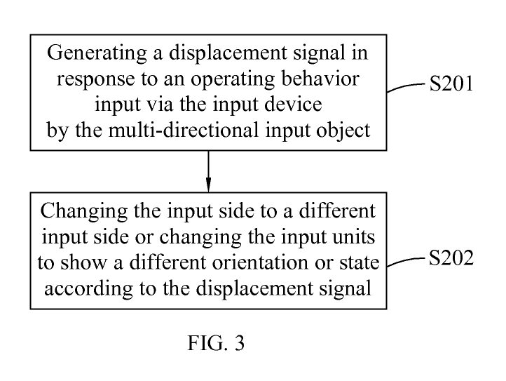

FIG. 3 is a flowchart showing the steps included in the multi-directional input method of the present invention for operating the multi-directional input object. When the electronic software is initialized and the multi-directional input object 1 is loaded according to the authentication process, the following steps are further included to operate the multi-directional input object 1.

In step S201, an operating behavior is performed via the input device, such as turning, moving, resizing, or deforming the multi-directional input object 1 and/or the input units 10, and a displacement signal corresponding to the operating behavior is generated.

In step S202, according to the displacement signal, the position of the multi-directional input object 1 is changed or switched to display the different input side thereof, or the input units 10 are changed or switched to present a different orientation, state, or appearance, so that different input options 100 are presented on the multi-directional input object 1 or the input units 10.

Please refer to FIG. 2 that shows the multi-directional input object 1 according to an embodiment of the present invention. As shown, the illustrated multi-directional input object 1 is a three-dimensional (3D) cube having total 27 input units 10. The input units 10 are 3D sub-cubes that together constitute the 3D cube of the multi-directional input object 1. Suppose an input option 100 is provided on every input unit 10 of all six sides, thus, the multi-directional input object 1 can provide total 27×6 input options 100, which are corresponding to the alphabet keys, numeral keys, and function keys on the conventional physical keyboard.

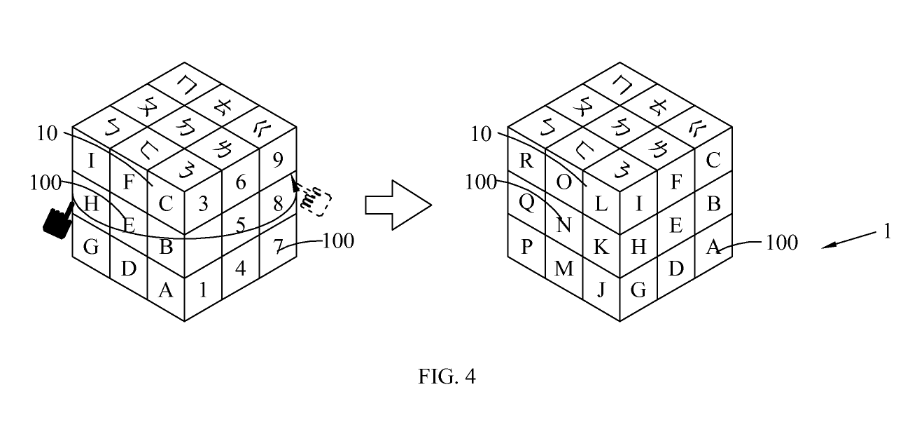

FIG. 4 shows an embodiment of operating the multi-directional input object 1 of the present invention. The illustrated multi-directional input object 1 is a 3D cube, and the input units 10 thereof are twenty-seven 3D sub-cubes, which together constitute the 3D cube of the multi-directional input object 1. In FIG. 4, the multi-directional input object 1 is horizontally turned to show another input side in response to a user's first operating behavior performed via the input device. In this first operating behavior, only the whole 3D cube is turned while none of the 3D sub-cubes of the input units 10 is turned.

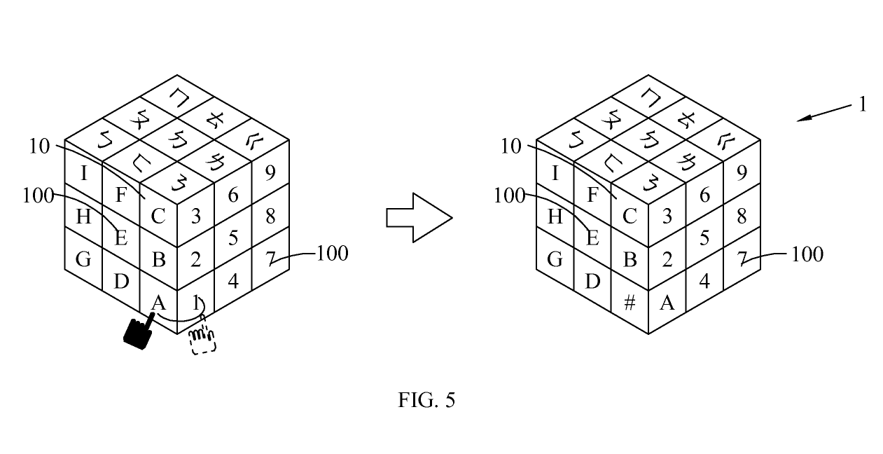

FIG. 5 shows another embodiment of operating the multi-directional input object 1 in the present invention. The illustrated multi-directional input object 1 is a 3D cube, and the input units 10 thereof are twenty-seven 3D sub-cubes, which together constitute the 3D cube of the multi-directional input object 1. In FIG. 5, the input units 10 of the multi-directional input object 1 are horizontally turned to show another input option 100 corresponded thereto in response to a user's second operating behavior performed via the input device. In this operation, only one or more of the 3D sub-cubes are turned while the whole 3D cube of the multi-directional input object 1 is not turned.

While the multi-directional input object 1 and the input units 10 shown in the aforementioned embodiment are virtual cubes, it is understood the multi-directional input object 1 and the input units 10 of the present invention are not limited to a cube shape, and may be changed to other shapes according to actual requirements in use. Further, the number of the multi-directional input object 1 and the number of the input units 10 may be increased or decreased according to actual need to thereby change the number of the input options 100. Moreover, the input options 100 of the multi-directional input object 1 are not limited to the alphabet keys, numeral keys, and function keys on the physical keyboard, but can be different colors or patterns. Furthermore, the input options 100 can be randomly arranged on different input units 10 at different positions thereof.

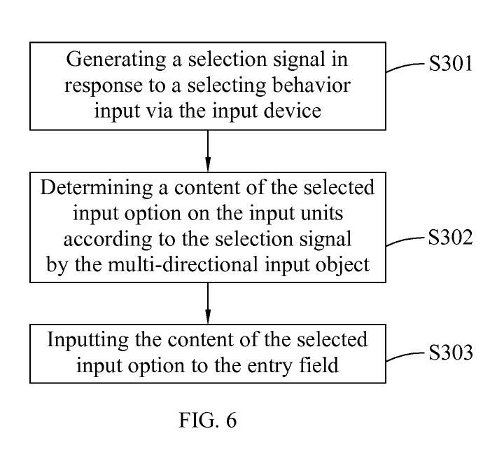

Please refer to FIG. 6 that is a flowchart showing the steps included in the multi-directional input method of the present invention for selecting one of the input options from one of the input units. When selecting a required authentication data via the input device, the following steps are further included.

In step S301, a selecting behavior is performed via the input device, and a selection signal is generated by the multi-directional input object 1 corresponding to the selecting behavior.

In step S302, according to a position at where the selection signal is generated, the multi-directional input object 1 determines a content of a selected input option 100 on one of the input units 10.

In step S303, the content of the selected input option 100 is input to the entry field 2.

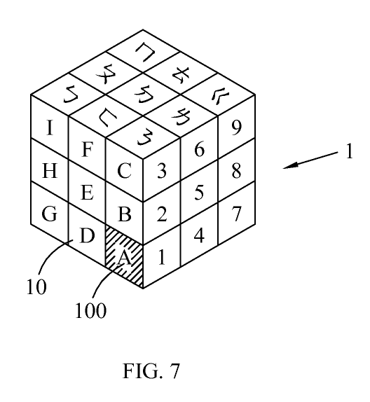

Please refer to FIG. 7 that shows an exemplified manner of selecting input option on an input unit by changing the outer appearance of the input unit according to an embodiment of the present invention. In FIG. 7, when one of the input options 100 on one of the input units 10 is selected according to the user's selecting behavior, the state or the appearance of the input unit 10 with the selected input option 100 is changed to remind the user that the input option 100 on that input unit 10 has been selected. Meanwhile, the content corresponding to the selected input option 100 is input to the entry field 2. To change the state or the appearance of the input unit 10, the input unit 10 can be shown in, for example, a translucent state, a transparent state, a highlight black on white, a highlighted white on black, a concave state, or a convex state.

Furthermore, for the authentication module to determine whether the user's behavior performed via the input device is a selecting behavior to select the input option 100 or an operating behavior to operate the multi-directional input object 1 or the input unit 10, a moving track generated by the operated input device is detected, or the duration of a click or the duration of a touch performed via the input device is detected.

For example, when the input device is moved from one position on the multi-directional input object 1 or on one input unit 10 to another position thereon, the moving track indicating such movement is determined as an operating behavior. On the other hand, when a user selects one of the input options 100 via the input device and stays at the selected input option for a duration reaching a preset threshold value, it is determined that the input option 100 is selected, so that the state or appearance of the input unit 10 is changed accordingly, and the content of the selected input option 100 is input to the entry field 2. In the present invention, the input device may be any one of a mouse, a keyboard, and a touch panel.

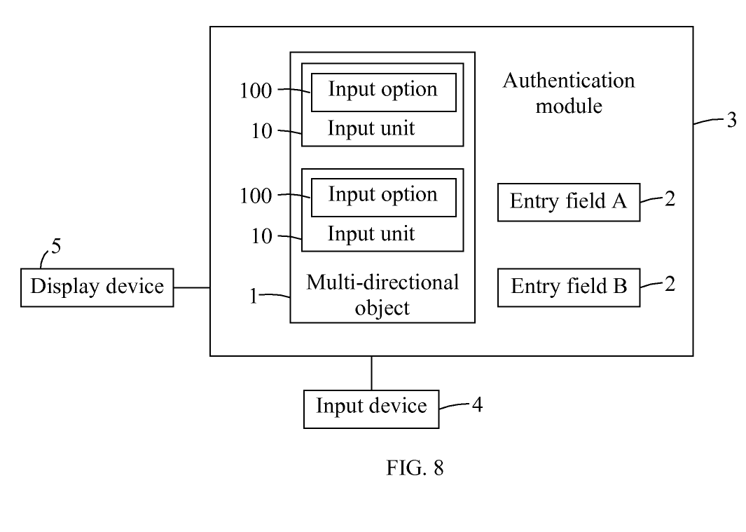

FIG. 8 is a block diagram of a multi-directional input electronic system according to the present invention. Please refer to FIG. 2 and FIG. 8 at the same time. The multi-directional input electronic system of the present invention comprises an authentication module 3, an input device 4, and a display device 5. The authentication module 3 includes a multi-directional input object 1 and at least one entry field 2. The multi-directional input object 1 includes a plurality of input sides, which together constitute a virtual polyhedron. On each of the input sides of the multi-directional input object 1, there is a plurality of input units 10, and each of the input units 10 corresponds to at least one input option 100. The display device 5 shows the multi-directional input object 1 and the entry field 2. The input device 4 is operated by a user to select and input required authentication data, so that the selected authentication data is input to the entry field 2. The authentication module 3 verifies the validity of the input authentication data. When the authentication module 3 verifies the input authentication data as valid, the next function of the electronic system is provided for use.

In the multi-directional input electronic system of the present invention, the input options 100 may be presented as characters, symbols, colors, or patterns. Further, the input options 100 at least correspond to the alphabet keys, numeral keys, and function keys on a physical keyboard. The input options 100 can be arranged on different input units 10 at different positions thereon. The multi-directional input object 1 generates a displacement signal in response to an operating behavior input via the input device 4. According to the displacement signal, the multi-directional input object 1 is changed or switched to a different input side, alternatively, one or more of the input units 10 are changed or switched to show a different input option 100 thereon. The multi-directional input object 1 may be a virtual regular polyhedron, such as a three-dimensional (3D) cube. In the case of a 3D cube, the input units 10 of the multi-directional input object 1 may be a plurality of 3D sub-cubes, which together constitute the 3D cube of the multi-directional input object 1.

The operating behavior can be, for example, the first operating behavior input via the input device 4 to thereby turn the overall multi-directional input object 1 to show another input side thereof or the second operating behavior input via the input device 4 to thereby turn one or more of the input units 10 of the multi-directional input object 1 to show another input option 100 thereof.

On the other hand, the multi-directional input object 1 generates a selection signal in response to a selecting behavior input via the input device 4. According to a position at where the selection signal is generated, the multi-directional input object 1 determines a selected input option 100 on one of the input units 10, and inputs a content of the selected input option 100 to the authentication entry field 2. The input unit 10 with the selected input option 100 can be changed in state or appearance of the input unit 10, such as changed to a translucent state, a transparent state, a concave state, or a convex state, to confirm the selection.

In brief, according to the multi-directional input method and electronic system of the present invention, through an operating behavior or a selecting behavior input via a input device, a multi-directional input object 1 may be changed to different input sides thereof, or one or more of multiple input units 10 on the multi-directional input object 1 may be changed to show different input options 100 of the input units 10, and contents of selected input options 100 may be input to an entry field generated by an authentication process, or the input options 100 may be randomly arranged on different input units 10 at different positions thereof. Therefore, even if the same authentication data is input via the input device 4 to the entry field 2, the user can select the input options representing the authentication data from different positions of the multi-directional input object 1 and from different positions of different input units 10. In this manner, it is able to prevent the authentication data from being illegally recorded and, accordingly, increase the security protection in inputting the authentication data.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A multi-directional input method applicable to an authentication process of an electronic system comprising the following steps:
loading a multi-directional input object by an authentication module embodiment in the electronic system and at least one entry field shown on a display device in the electronic system; the multi-directional input object being a 3D object and comprising a plurality of input sides, each of the plurality of input sides comprising a plurality of input units, and each of the plurality of input units corresponding to at least one input option;
operating the multi-directional input object via an input device of the electronic system to sequentially select more than one of the input units, and the input options separately corresponding to the selected input units and constituting an authentication data;
determining whether a confirmation message inputted via the input device is received or not by the authentication module;
receiving the authentication data in the entry field by the authentication module when the confirmation message has been received;
verifying whether the input authentication data is valid via the authentication process by the authentication module; and
providing a next function and operation of the electronic system available by the authentication module when the input authentication data has been verified as valid.

2. The multi-directional input method as claimed in claim 1 further comprising the following step when the confirmation message is not received: continuing the operation of the multi-directional input object to sequentially select the plurality of input units, and the input options separately corresponding to the selected input units and constituting an authentication data.

3. The multi-directional input method as claimed in claim 1 further comprising one of the following steps when the input authentication data is verified as invalid via the authentication process by the authentication module:
operating the multi-directional input object again to sequentially select the plurality of the input units by the authentication module, and the input options separately corresponding to the selected input units and constituting an authentication data;
verifying the validity of the input authentication data again by the authentication module;
ending the authentication process by the authentication module; and
shutting down the electronic system by the authentication module.

4. The multi-directional input method as claimed in claim 1 further comprising the following step when the input authentication data is verified as invalid by the authentication process run by the authentication module:
providing options in a window on the screen to the user of the electronic system;
selectively operating the multi-directional input object again to sequentially select the plurality of the input units by the authentication module if the user select the option thereof, and the input options separately corresponding to the selected input units constituting an authentication data;
selectively verifying the validity of the input authentication data again by the authentication module if the user select the option thereof;
selectively ending the authentication process by the authentication module if the user select the option thereof; and
selectively shutting down the electronic system by the authentication module if the user select the option thereof.

5. The multi-directional input method as claimed in claim 1, wherein the electronic software is selected from the group consisting of an operating system and an application program.

6. The multi-directional input method as claimed in claim 1, wherein each of the input options is presented as any one of characters, symbols, colors, and patterns.

7. The multi-directional input method as claimed in claim 1, wherein the input options correspond to alphabet keys, numeral keys, and function keys shown on a physical keyboard.

8. The multi-directional input method as claimed in claim 1, wherein, in the authentication process, the input options are randomly arranged on the plurality of input units at different positions thereof.

9. The multi-directional input method as claimed in claim 1, further comprising the following steps for operating the multi-directional input object when the electronic software is initialized and the multi-directional input object is loaded according to the authentication process:
generating a corresponding displacement signal in response to an operating behavior inputted via the input device by the authentication module; and
in response to the displacement signal, the multi-directional input object changing or switching the positions of the plurality of input sides thereof, or at least one of the plurality of input units being changed or switched to present different input options thereof.

10. The multi-directional input method as claimed in claim 9, wherein the operating behavior is selected from the group consisting of turning, moving, resizing, enlarging, and deforming the multi-directional input object.

11. The multi-directional input method as claimed in claim 9, wherein the multi-directional input object is a 3D cube, the plurality of input units are 3D sub-cubes and constitute the 3D cube.

12. The multi-directional input method as claimed in claim 9, wherein the multi-directional input object is turned to show different input sides in response to a first operating behavior input via the input device while all the sub-cubes are not turned separately.

13. The multi-directional input method as claimed in claim 9, wherein at least one of the sub-cubes is turned to show different input options thereof in response to a second operating behavior input via the input device.

14. The multi-directional input method as claimed in claim 9 further comprising the following steps for selecting a required authentication data via the input device:
performing a selecting behavior via the input device by the user;
generating a selection signal corresponding to the selecting behavior by the authentication module;
determining the content of a selected input option on the corresponding input unit by the authentication module according to the position at where the selection signal is generated; and
inputting the content of the selected input option to the entry field generated by the authentication process.

15. The multi-directional input method as claimed in claim 14 further comprising the step of:
changing the state or the appearance of the plurality of input units comprising the selected input option;
inputting the content of the selected input option to the entry field.

16. The multi-directional input method as claimed in claim 15, wherein the state or the appearance of the plurality of input units comprising the selected input option is changed to any one of a translucent state, a transparent state, a concave state, and a convex state.

17. The multi-directional input method as claimed in claim 15, wherein the authentication process determines the operating behavior and the selecting behavior by detecting a moving track, the duration of a click, or the duration touch performed via the input device.

18. A multi-directional input electronic system, comprising:
an authentication module comprising a multi-directional input object and at least one entry field; the multi-directional input object having a plurality of input sides; the plurality of input sides constituting a virtual regular polyhedron; each of the input sides having a plurality of input units and each of the plurality of input units corresponding to at least one input options;
an input device being able to select and input required authentication data; and
a display device being able to display the multi-directional input object and the entry field of the authentication module;
wherein the input device inputs the authentication data to the entry field, and the authentication module verifies the validity of the input authentication data; when the input authentication data is verified by the authentication module as valid, the next function of the electronic system is provided for use.

19. The multi-directional input electronic system as claimed in claim 18, wherein the input options are selected from the group consisting of characters, symbols, colors, and patterns.

20. The multi-directional input electronic system as claimed in claim 18, wherein the input options correspond to alphabet keys, numeral keys, and function key on a physical keyboard.
